(19) United States
(12) Patent Application Publication
(10) Pub. No.: US 2010/0017107 A1
(43) Pub. Date: Jan. 21, 2010

(54) TRAVELING VEHICLE

(75) Inventors: Takafumi Miyake, Tokyo (JP); Katsunori Doi, Tokyo (JP)

Correspondence Address: BACON & THOMAS, PLLC, 625 SLATERS LANE, FOURTH FLOOR, ALEXANDRIA, VA, 22314-1176, US

(73) Assignee: Kabushikikaisha Equos Research, Tokyo (JP)

(21) Appl. No.: 12/518,782

(22) PCT Filed: Dec. 26, 2007
(86) PCT No.: PCT/JP2007/074951

§ 371 Date: Jun. 11, 2009

(30) Foreign Application Priority Data
Dec. 27, 2006 (JP) 2006-352115

(51) Int. Cl. G06F 19/00

(52) U.S. Cl. 701/124

(57) ABSTRACT

A traveling vehicle (1) includes a vehicle body (2) that has an occupant mounting portion that mounts an occupant, and a wheel (8) that is provided on a shaft and rotatably supported on the vehicle body (2). The traveling vehicle (1) is characterized by including: occupant dismount detection means (152) that detects the occupant getting of the occupant mounting portion (3); and control means (100) that has a center of gravity position correcting function that holds a center of gravity position of the traveling vehicle (1) on a vertical line that passes through a center of the wheel (8), wherein the control means (100) cancels the center of gravity position correcting function if the occupant dismount detection means (152) detects the occupant getting off.

### TECHNICAL FIELD

The present invention relates to a vehicle that has a vehicle body, wheels provided parallel, and a mechanism that controls the posture of the vehicle body with respect to the wheels. More specifically, the present invention relates to a traveling vehicle that is capable of precise movement through a simple operation when an operator moves the vehicle after an occupant gets off the vehicle.

### BACKGROUND ART

In related art, a vehicle transports an individual on a ground having an irregular surface. The vehicle includes a support body for supporting persons and a ground contact module that is movably installed on the support body, wherein the support body and the ground contact module structure an assembly. The ground contact module is operated so as to support the persons in the support body on the ground. The ground contact module is also directed to a vertical position and forms longitudinal and lateral planes that cross each other. A motored drive device installed on the assembly and connected to the ground contact module moves the assembly and the persons accompanying the assembly on the ground. (See Patent Document 1.)

Patent Document 1: Japanese Patent Application Publication No. JP-A-2003-305088

### DISCLOSURE OF THE INVENTION

### Problem to be Solved by the Invention

In the case of a lightweight vehicle having a small vehicle body that is operated by operating means such as a joystick, as with the invention described in Patent Document 1, when moving a short distance in a narrow space is desired, e.g., in order to park in a narrow space, there are times when the vehicle cannot be operated as intended using the operating means and the vehicle is more easily operated instead by the occupant getting off the vehicle and pushing the vehicle.

However, the vehicle described above adds torque so as to perform a correction with respect to an external force or displacement of the position of the center of gravity. As a consequence, external pushing of the vehicle ordinarily causes the generation of an opposing force, which makes it difficult for the vehicle to be moved after the occupant gets off.

The present invention solves the above problem, and it is an object of the present invention to provide a traveling vehicle that does not generate an opposing force to a pushing force on the traveling vehicle even when an operator externally pushes the traveling vehicle after an occupant gets off the traveling vehicle.

### Means for Solving the Problem

Thus, according to the present invention, a traveling vehicle includes a vehicle body that has an occupant mounting portion that mounts an occupant; and a wheel that is provided on a shaft and rotatably supported on the vehicle body. The traveling vehicle is characterized by further including: occupant dismount detection means that detects the occupant getting off the occupant mounting portion; and control means that has a center of gravity position correcting function that holds a center of gravity position of the traveling vehicle on a vertical line that passes through a center of the wheel, wherein the control means cancels the center of gravity position correcting function if the occupant dismount detection means detects the occupant getting off.

The traveling vehicle is also characterized by further including vehicle body inclination angle detection means that detects an inclination angle of the vehicle body, wherein the control means controls the posture of the traveling vehicle based on the detected inclination angle and the center of gravity position correcting function if the occupant dismount detection means has not detected the occupant getting off the traveling vehicle, and controls the posture based on the detected inclination angle if the occupant dismount detection means has detected the occupant getting off the traveling vehicle.

In addition, the traveling vehicle is characterized by further including notification means that notifies to the outside when the center of gravity position correcting function is canceled.

The traveling vehicle is additionally characterized by further including: external force measurement means that measures an externally applied force when the center of gravity position correcting function is canceled; and assist means that applies an assist torque to the wheel depending on a measurement value of the external force measurement means.

### EFFECTS OF THE INVENTION

According to claim 1 of the present application, a traveling vehicle includes a vehicle body that has an occupant mounting portion that mounts an occupant; and a wheel that is provided on a shaft and rotatably supported on the vehicle body. The traveling vehicle further includes: occupant dismount detection means that detects the occupant getting off the occupant mounting portion; and control means that has a center of gravity position correcting function that holds a center of gravity position of the traveling vehicle on a vertical line that passes through a center of the wheel, wherein the control means cancels the center of gravity position correcting function if the occupant dismount detection means detects the occupant getting off. Thus, even if the traveling vehicle is externally pushed after the occupant gets off the traveling vehicle, there is no generation of a force that opposes the pushing force on the traveling vehicle.

According to claim 2 of the present application, the traveling vehicle further includes vehicle body inclination angle detection means that detects an inclination angle of the vehicle body. The control means controls the posture of the traveling vehicle based on the detected inclination angle and the center of gravity position correcting function if the occupant dismount detection means has not detected the occupant getting off the traveling vehicle, and controls the posture based on the detected inclination angle if the occupant dismount detection means has detected the occupant getting off the traveling vehicle. Therefore, the traveling vehicle can be safely moved while also maintaining the posture of the traveling vehicle.

According to claim 3 of the present application, the traveling vehicle further includes notification means that notifies to the outside when the center of gravity position correcting function is canceled. Therefore, it is possible to encourage caution so that a person from outside does not mistakenly apply to the traveling vehicle a force other than that for operation.

According to claim 4 of the present application, the traveling vehicle further includes external force measurement means that measures an externally applied force when the center of gravity position correcting function is canceled; and assist means that applies an assist torque to the wheel depending on a measurement value of the external force measurement means. Therefore, the traveling vehicle can be easily pushed with little force when the occupant gets of the traveling vehicle and the traveling vehicle is externally pushed.

### BRIEF DESCRIPTION OF THE DRAWINGS

FIG. 1A is a frontal view of a vehicle according to an embodiment of the present invention, and FIG. 1B is a side view of the vehicle.

FIG. 2 is a figure that shows a balancer.

FIG. 3 is a block diagram that shows a system configuration of the vehicle.

FIG. 4 is a schematic diagram that measures the displacement of a center of gravity position.

FIG. 5 is a schematic diagram that estimates the displacement of the center of gravity position.

FIG. 6 is a figure that corrects the displacement of the center of gravity position by tilting a vehicle body.

FIG. 7 is a figure that corrects the displacement of the center of gravity position by using the balancer.

FIG. 8 is a figure that corrects the displacement of the center of gravity position by moving a seat.

FIG. 9 shows figures of operation states when the vehicle is not mounted.

FIG. 10 shows figures of operation states when the vehicle is not mounted.

FIG. 11 is a figure that shows a flowchart of a control when the vehicle is not mounted.

FIG. 12 is a flowchart for determining an assist torque amount.

FIG. 13 is a signal transmission diagram for determining the assist torque amount.

FIG. 14 is a flowchart for correcting a postural change using the assist torque.

FIG. 15 is a figure that shows an assist start signal serving as another embodiment.

### BEST MODES FOR CARRYING OUT THE INVENTION

An embodiment that serves as an example of the present invention will be described below with reference to the accompanying drawings.

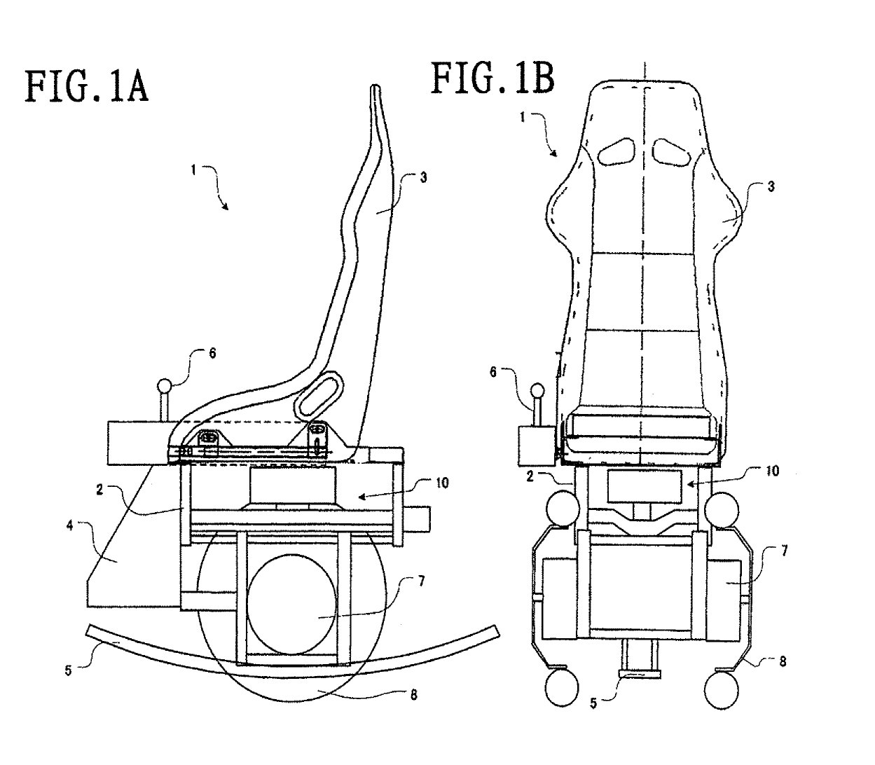

FIG. 1 shows a traveling vehicle according to the present embodiment. In the figure, reference numeral 1 denotes the traveling vehicle, 2 denotes a vehicle body, 3 denotes a seat that serves as an example of an occupant mounting portion, 4 denotes a footrest, 5 denotes a fall-prevention bar, 6 denotes a slider knob that serves as an example of an input device, 7 denotes a wheel motor that serves as an example of assist means, 8 denotes a wheel, and 10 denotes a balancer.

The traveling vehicle 1 includes the vehicle body 2, the seat 3, the footrest 4, the fall-prevention bar 5, the slider knob 6, the wheel motors 7 and the wheels 8 for the right and left sides, and the balancer 10. Regarding the vehicle body 2, an upper portion thereof is mounted with the seat 3 on which an occupant M sits, and a generally center portion thereof is mounted with the balancer 10. Meanwhile, the front of the vehicle body 2 is connected with the footrest 4 on which the feet of the occupant M are placed, and a lower portion of the vehicle body 2 is connected with the fall-prevention bar 5 that extends forward and backward. The seat 3 is supported by the vehicle body, and includes a seat bottom portion on which the occupant M is mounted and a seat back that serves as a backrest for the occupant M. The height of the seat back is preferably higher than the head of the occupant M. The slider knob 6 is operated by the occupant M that sits in the seat 3, and is supported by the vehicle body 2. The right and left wheel motors 7 are supported on a common shaft by the vehicle body 2 and capable of independently controlling forward and backward driving forces. Also, the right and left wheel motors 7 are connected to the wheels 8 that are rotatably supported by the vehicle body 2. The balancer 10 is installed on the vehicle body 2 and controls the posture of the traveling vehicle 1.

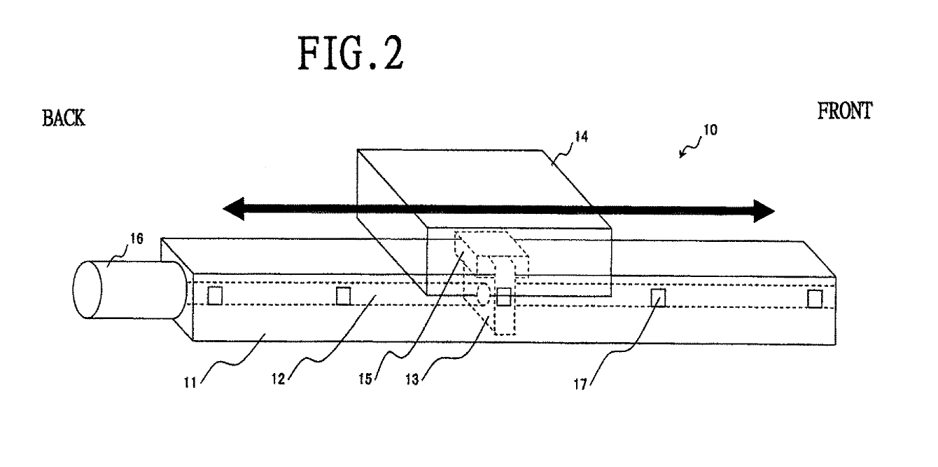

FIG. 2 is a figure that shows the balancer 10 of the present embodiment. For the balancer 10, a rail 11 is provided with a ball screw 12, and the ball screw 12 is held by a nut block 13. In addition, a slider 15 loaded with a weight 14 is moved along the rail 11 by a balancer drive actuator 16 that is a servo motor or the like. The position of the weight 14 is detected by a balancer position sensor 17. A battery, an ECU, and the like may be employed as the weight 14.

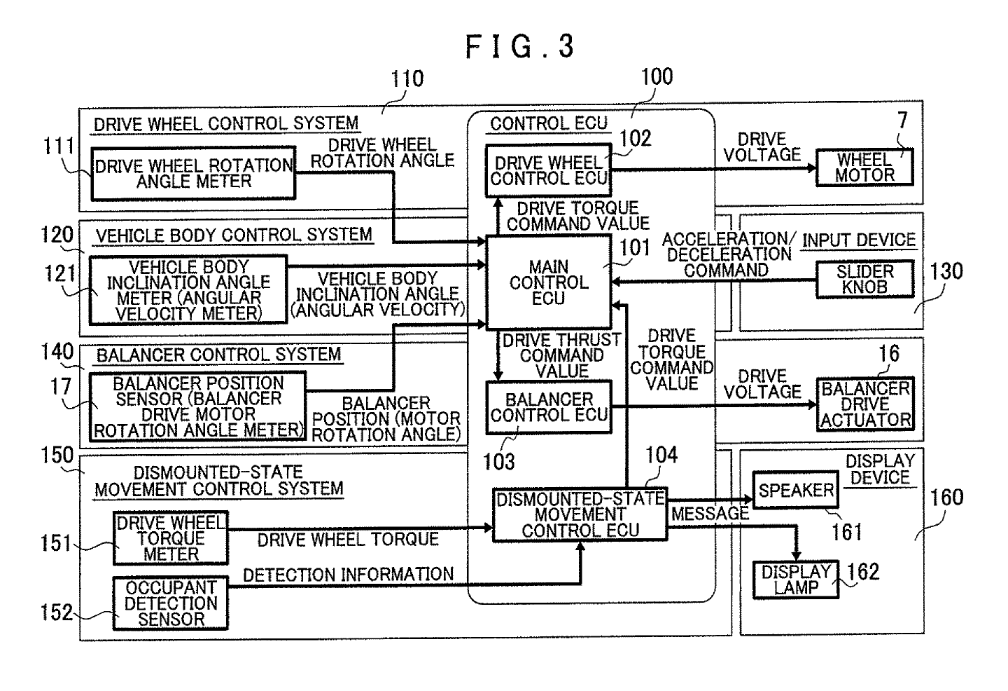

FIG. 3 is a block diagram that shows a system configuration of the traveling vehicle 1 of the present embodiment. A control ECU 100 that serves as control means is formed from a main control ECU 101, a drive wheel control ECU 102 that controls the wheel motor 7 and serves as a drive wheel actuator, a balancer ECU 103 that controls the balancer drive actuator 16, and a dismounted-state movement control ECU 104 that controls the movement of the vehicle when the occupant M gets of the vehicle.

A drive wheel control system 110 includes a drive wheel rotation angle meter 111 that detects the rotation angle of the drive wheel, and also includes the wheel motor 7. A vehicle body control system 120 includes a vehicle body inclination angle meter 121 that detects the inclination angle of the vehicle body. Note that an angular velocity meter may be used instead of the vehicle body inclination angle meter 121, and the angle subsequently detected by integrating signals.

A balancer control system 140 includes the balancer position sensor 17 that detects the position of the balancer, and the balancer drive actuator 16. Note that a balancer drive motor rotation angle meter or the like that detects the rotation angle of a balancer drive motor may be applied instead of the balancer position sensor 17.

An input device 130 may instruct acceleration/deceleration and handling of the slider knob 6, a joystick, and the like.

A display device 160, which serves as an example of notification means, informs a state of the traveling vehicle to the outside, and includes a speaker 161 and a display lamp 162.

A dismounted-state movement control system 150 that characterizes the present embodiment includes a drive wheel torque meter 151 that is a combination of a potentiometer and a spring that detect a torque of the drive wheel, and occupant detection means 152 such as a seating sensor that detects an occupant.

Ordinarily in these systems, command signals for acceleration/deceleration and steering are input from the input device 130 to the main control ECU 101, and current states of the traveling vehicle 1 are input to the main control ECU 101 from the drive wheel rotation angle meter 111, the vehicle body inclination angle meter 121, the balancer position sensor 17, and the like.

At least one signal among these is computed in the main control ECU 101, and the main control ECU 101 sends a signal that serves as a drive torque command value to the drive wheel control ECU 101 and sends a signal that serves as a drive thrust command value to the balancer control ECU 103.

The drive wheel control ECU 102 outputs the sent drive torque command value to the wheel motor 7 as a drive voltage. Meanwhile, the balancer control ECU 103 outputs the sent drive thrust command value to the balancer drive actuator 16 as a drive voltage.

By using such a system configuration, the traveling vehicle 1 is capable of moving while holding the seat 3 in an inverted state.

During a dismounted-state movement control, current states of the traveling vehicle 1 are input from the drive wheel torque meter 151, the occupant detection means 152, and the like. Based on such input signals, the dismounted-state movement control ECU 104 may execute an assist torque command for the wheel motor 7 through the main control ECU 101 and the drive wheel control ECU 102, or execute a balancer movement command for the balancer drive actuator 16 through the main control ECU 101 and the balancer control ECU 103.

Note that when the current torque of the wheel motor 7 and the existence of an occupant are input to the dismounted-state movement control ECU 104 from the drive wheel torque meter 151 and the occupant detection means 152, the dismounted-state movement control ECU 104 may control the display device 160 such as the speaker 161 and the display lamp 162 without sending a signal to the main control ECU 101.

A center of gravity position correcting function in the present embodiment will be described next. The center of gravity position correcting function involves the main control ECU controlling the wheel motor 7, the balancer 10, and the like in order to correct a center of gravity position G of the traveling vehicle 1 to a vertical line that passes through a wheel center of gravity when the center of gravity position G of the traveling vehicle 1 deviates forward or backward from the vertical line that passes through the wheel center of gravity.

To determine whether the center of gravity position G is displaced, the center of gravity position G may be measured using a measuring instrument or estimated from a history of control results.

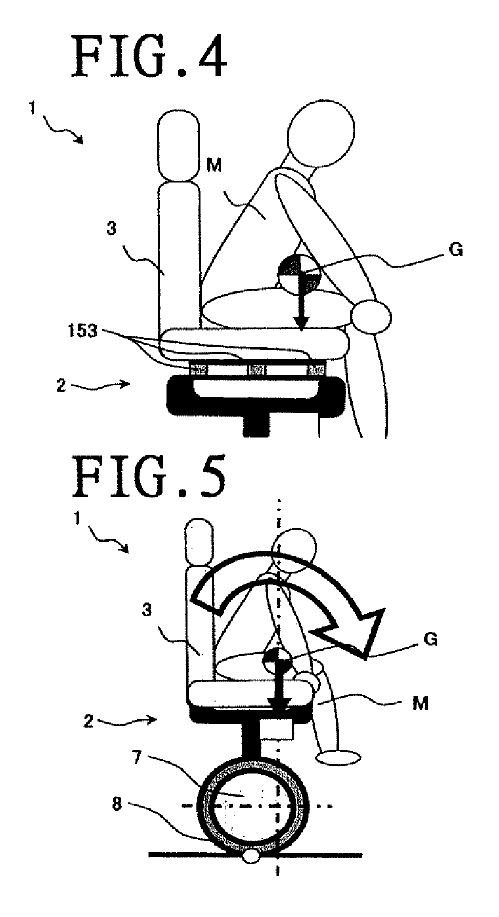

If measured using a measuring instrument, a plurality of load meters 153 or the like are disposed underneath the seat 3 as shown in FIG. 4, and the center of gravity position G and weight of the occupant M are measured based on the load distribution in order to calculate the overall center of gravity position G of the traveling vehicle 1 with the occupant M. In such case, data for the center of gravity position G of the vehicle body 2 is stored in advance.

If estimated from the history of control results, an external disturbance observer or the like as shown in FIG. 5 is used to estimate the displacement of the center of gravity based on the history of torque input and postural changes of the vehicle body. For example, it is estimated that the vehicle body 2 tends to lean forward due to the displacement of the center of gravity position G forward, even though the vehicle body 2 is not actually inclined.

If it is determined in this manner that the center of gravity position G is displaced, the displacement of the center of gravity position G must be corrected. Correction methods include inclining the vehicle body 2, utilizing the balancer 10, and moving the seat 3.

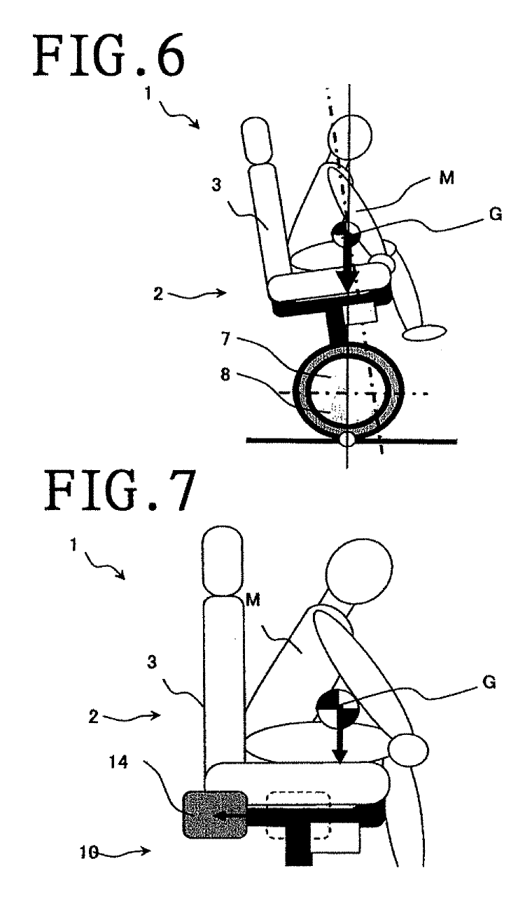

In the case of inclining the vehicle body 2, as shown in FIG. 6, the inclination angle of the vehicle body 2 is controlled by the driving force of the wheel motor 7 such that the center of gravity position G exists on the vertical line that passes through the wheel center of gravity.

In the case of utilizing the balancer 10, as shown in FIG, 7, the weight 14 of the balancer 10 is controlled by the balancer drive actuator 16 such that the center of gravity position G exists on the vertical line that passes through the wheel center of gravity.

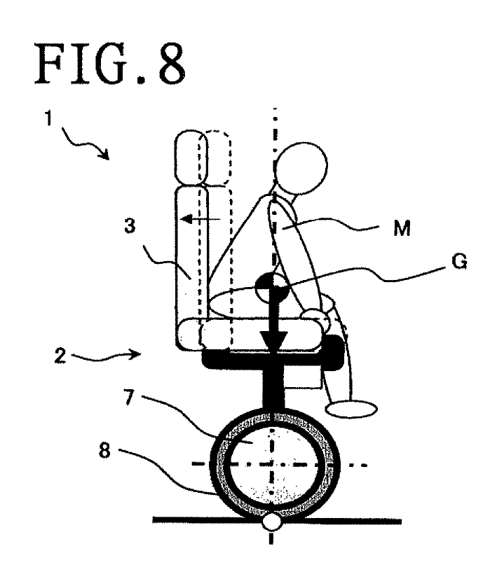

In the case of moving the seat 3, as shown in FIG. 8, the seat 3 is controlled to slide such that the center of gravity position G exists on the vertical line that passes through the wheel center of gravity.

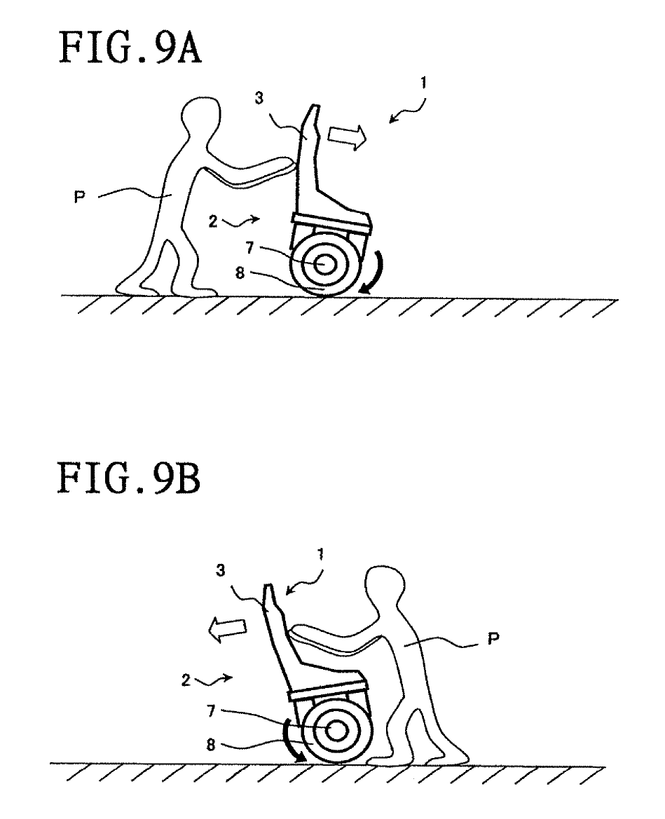

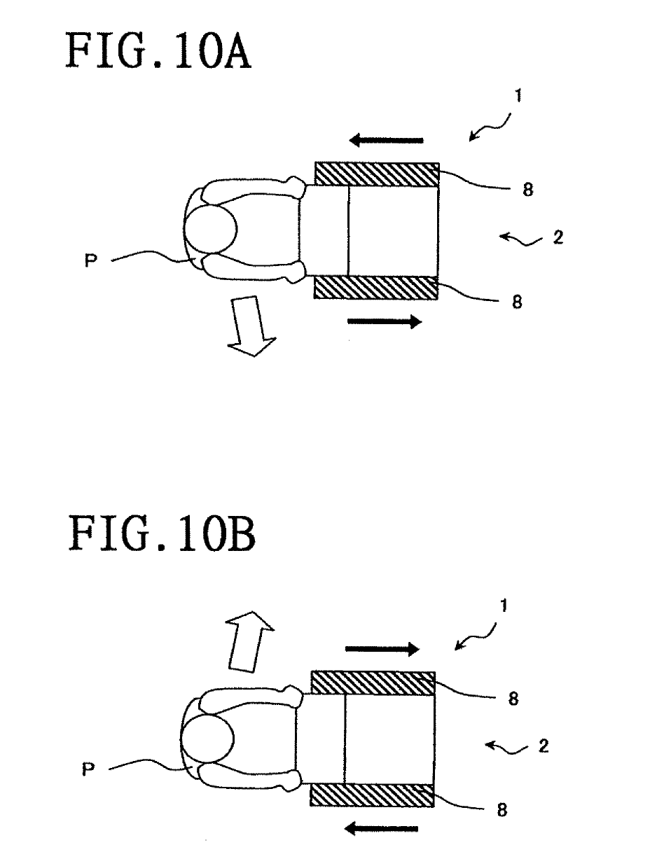

The dismounted-state movement control will be described next. FIGS. 9 and 10 are figures that schematically show operation states for executing the dismounted-state movement control.

FIG. 9A shows an example where, after the occupant M gets off, an operator P pushes the traveling vehicle 1 forward from behind to move the traveling vehicle 1. In such case, the occupant M getting off and the traveling vehicle 1 being pushed forward from behind, or other switches and the like, are detected and the center of gravity position correcting function is cancelled. An assist torque may be applied thereafter to the wheel 8 by the wheel motor 7 in the direction that the traveling vehicle 1 advances forward.

FIG. 9B shows an example where, after the occupant M gets off, the operator P pushes the traveling vehicle 1 backward from the front to move the traveling vehicle 1. In such case, the occupant M getting off and the traveling vehicle 1 being pushed backward from the front, or other switches and the like, are detected and the center of gravity position correcting function is cancelled. An assist torque may be applied thereafter to the wheel 8 by the wheel motor 7 in the direction that the traveling vehicle 1 advances backward.

FIG. 10A shows an example where, after the occupant M gets off, the operator P pushes the traveling vehicle 1 rightward from behind to change the direction of the traveling vehicle 1 leftward. In such case, the occupant M getting off and the traveling vehicle 1 being pushed rightward from behind, or other switches and the like, are detected and the center of gravity position correcting function is cancelled. An assist torque may be applied thereafter to the wheel 8 by the wheel motor 7 in the direction that the right wheel advances forward and in the direction that the left wheel advances backward.

FIG. 10B shows an example where, after the occupant M gets off, the operator P pushes the traveling vehicle 1 leftward from behind to change the direction of the traveling vehicle 1 rightward. In such case, the occupant M getting off and the traveling vehicle 1 being pushed leftward from behind, or other switches and the like, are detected and the center of gravity position correcting function is cancelled. An assist torque may be applied thereafter to the wheel 8 by the wheel motor 7 in the direction that the left wheel advances forward and in the direction that the right wheel advances backward.

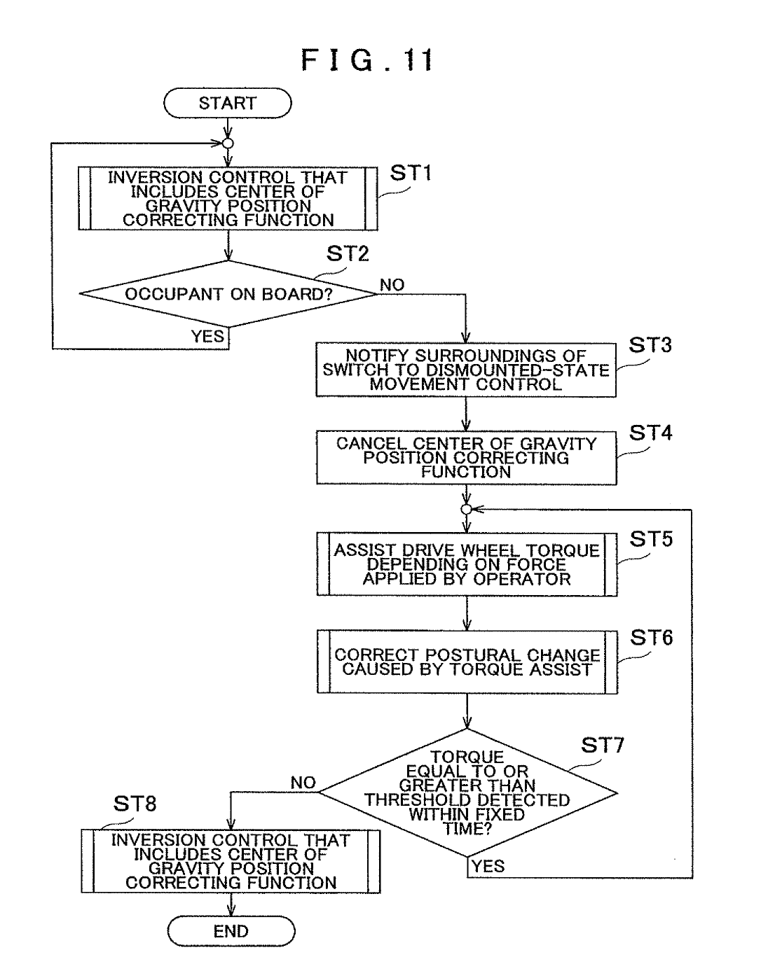

FIG. 11 shows a flowchart of the dismounted-state movement control. First, at step 1, the traveling vehicle 1 is subjected to an inversion control using the center of gravity position correcting function (ST1). Next, at step 2, the occupant detection means 152, which serves as an example of occupant dismount detection means, is used to determine whether the occupant M is mounted on the seat 3 (ST2). If the occupant M is mounted, the processing returns to step 1. If the occupant M is not mounted, then at step 3, the display device 160 or the like is used to notify the surroundings of a switch to the dismounted-state movement control (ST3). At step 4, the center of gravity position correcting function is subsequently cancelled (ST4).

Next, at step 5, an assist torque is applied by the wheel motor 7 depending on the pushing force of the operator P (ST5).

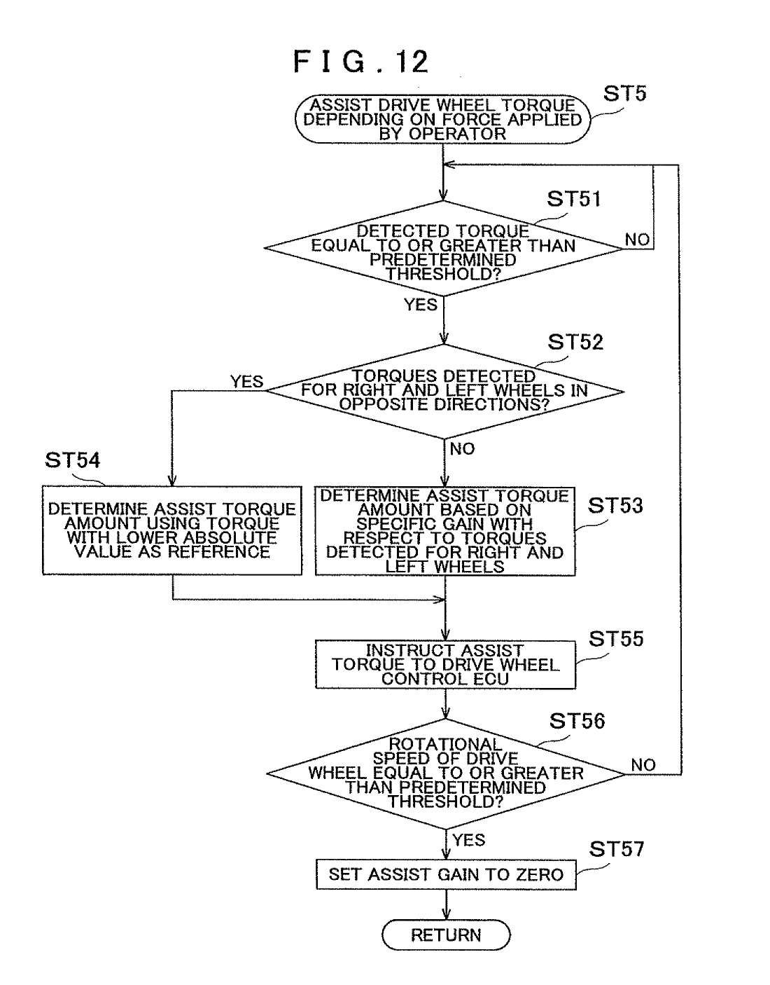

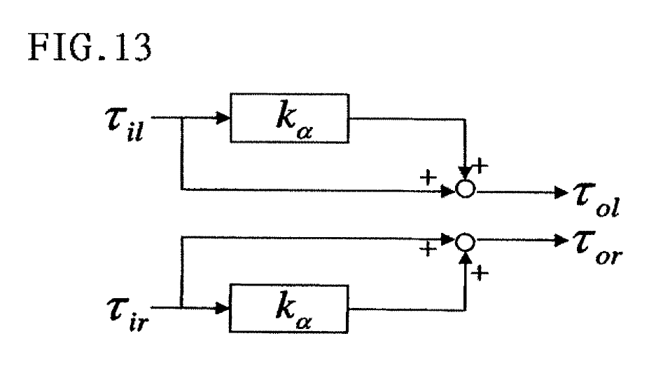

A flowchart for applying the assist torque will be described here. FIG. 12 is a subroutine at step 5. First, at step 51, it is determined whether the torque detected by the drive wheel torque meter 151 is equal to or greater than a predetermined threshold (ST51). This is to provide a dead zone so that the detection is not oversensitive to minimal torque. If the torque is not equal to or greater than the predetermined threshold, the processing returns to step 51. If the torque is equal to or greater than the predetermined threshold, then it is determined at step 52 whether torques detected for the right and left wheels are in opposite directions (ST52). If the torques are not in opposite directions, assist torque amounts are computed at step 53 based on a specific gain with respect to the torques detected for the right and left wheels by the drive wheel torque meter 151, as shown in FIG. 13 (ST53). In the figure, τᵢₗ is a left wheel torque, τₒₗ is a left wheel assist torque, τᵢᵣ is a right wheel torque, τₒᵣ is a right wheel assist torque, and kα is a gain. The operator applying a different amount of force to the right and left sides of the vehicle generates a difference in the torque amounts measured for the right and left wheels, respectively, and also makes it possible to turn and move the vehicle.

At step 52, if the directions of the torques detected for the right and left wheels are opposite and a difference in the absolute values thereof is equal to or greater than a predetermined threshold, this is interpreted as the operator P trying to turn at that location. Thus, at step 54, an assist torque is calculated using the torque with the lower absolute value among the torques detected for the right and left wheels as a reference, and a control is carried out such that the same torque is applied to the right and left wheels (ST54).

Although the drive torque meter 151 is provided in the present embodiment, instead of the drive torque meter it is also possible to measure a consumption current of a drive motor, and estimate a torque amount generated due to an operation of the operator based on such fluctuations.

Next, at step 55, a command value for an assist torque portion is sent to the drive wheel control ECU 102, and the assist torque is applied to the wheel motor 7 (ST55).

At step 56, the drive wheel rotation angle meter 111 is used to determine whether a rotational speed of the drive wheel is equal to or greater than a predetermined threshold (ST56), If the rotational speed of the drive wheel is not equal to or greater than the predetermined threshold, the processing returns to step 51. If the rotational speed of the drive wheel is equal to or greater than the predetermined threshold, an assist gain is set to zero and no assist torque is applied at step 57 (ST57). The processing then returns to the main routine.

At step 6, a postural change caused by the assist torque is corrected (ST6).

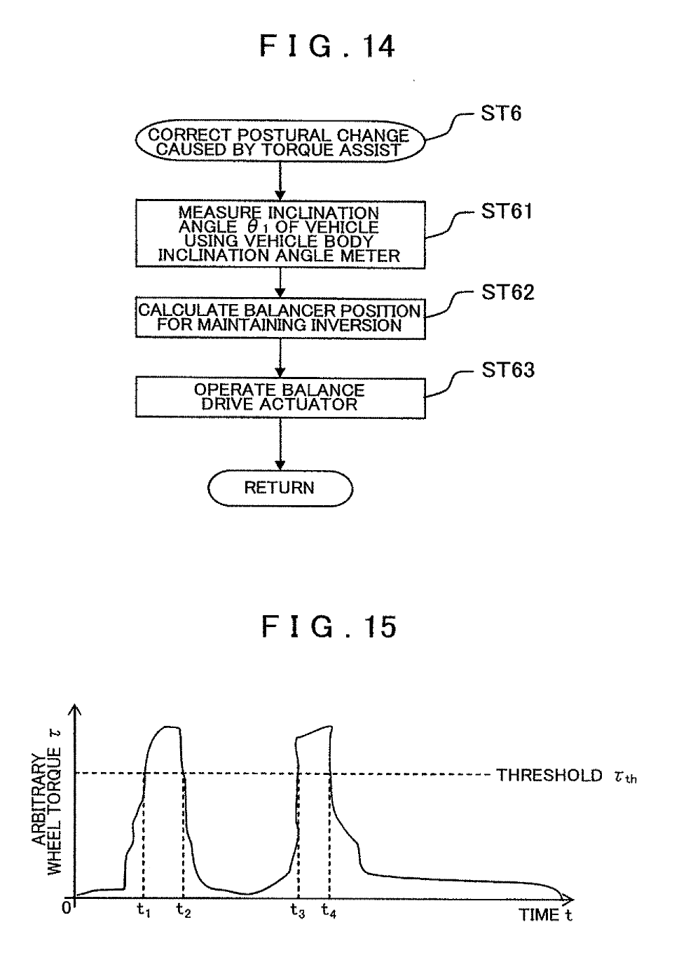

A flowchart shown in FIG. 14 of a subroutine that corrects a postural change caused by the assist torque will be described here. First, at step 61, the vehicle body inclination angle meter 121 is used to measure an inclination angle θ₁ of the vehicle body 2 (ST61). At step 62, a position of the weight 14 of the balancer 10 for maintaining inversion is calculated (ST62). Next, at step 63, the balancer drive actuator 142 is operated (ST63), after which the processing returns to the main routine.

At step 7, the drive wheel torque meter 151 is used to determine whether a torque equal to or greater than a predetermined threshold has been detected within a fixed time (ST7). If a torque equal to or greater than the predetermined threshold has been detected within the fixed time, the processing returns to step 5. If a torque equal to or greater than the predetermined threshold has not been detected within the fixed time, the center of gravity position correcting function is restarted at step 8 (ST8). The processing at steps 7 and 8 is executed if there is a risk of the traveling vehicle 1 moving due to an external disturbance or the like other than the operator P after the center of gravity position correcting function is canceled, when the occupant M gets off and moves away from the vehicle without performing moving operation.

Note that the application of assist torque at steps 5 and 6 is not necessary.

In the present embodiment, the occupant detection means 152 is used to detect the existence of an occupant at step 2, which serves as a reference for switching to the dismounted-state movement control. However, as another embodiment, external force detection means that serves as an example of the occupant dismount detection means may be used to detect an assist start signal. Such embodiments may be used singly or in combination as a multiple system to make determinations.

Detection of the assist start signal by the external force detection means, which serves as another embodiment, will be described here. For detection of the assist start signal, the operator P explicitly shifts to a torque assist mode to execute an operation. In the present embodiment, a movement operation is executed such that torque equal to or greater than a predetermined threshold is detected in the moving direction at a specific cycle. For example, as shown in FIG. 15, a shift is made to the assist mode only when the following conditions are met: there are two or more torques equal to or greater than the threshold τₜₕ, the durations (t₂−t₁) and (t₄−t₃) of the two or more torques that are equal to or greater than τₜₕ are equal to or greater than a predetermined threshold tₜₕ, and a recurrence interval (t₃−t₂) of the two or more torques equal to or greater than τₜₕ is at least a predetermined threshold tₘᵢₙ and at most a predetermined threshold tₘₐₓ.

Note that in addition to these embodiment for switching to the dismounted-state movement control at step 2, an assist mode switch that serves as an example of the occupant dismount detection means may be provided and set such that an assist is performed only when the switch is turned on.

In the case where a torque large enough to possibly cause the traveling vehicle 1 to fall over is applied, the torque assist may be stopped without moving forward or backward for correction. Furthermore, if the surroundings are monitored and an obstacle is present, the torque assist may be controlled to stop. Moreover, the occupant M and the operator P may be the same person, but are not necessarily the same person in all cases.

According to the present embodiment, the traveling vehicle 1 includes a vehicle body 2 that has a seat 3 that mounts an occupant M, a wheel 8 that is provided on a shaft and rotatably supported on the vehicle body 2. The traveling vehicle 1 further includes: occupant detection means 152 that detects the occupant M getting off the seat 3; and a control ECU 100 that has a center of gravity position correcting function that holds a center of gravity position of the traveling vehicle 1 on a vertical line that passes through a center of the wheel 8, wherein the control ECU 100 cancels the center of gravity position correcting function if the occupant detection means 152 detects the occupant M getting off. Thus, even if the traveling vehicle 1 is externally pushed after the occupant M gets off the traveling vehicle 1, there is no generation of a force that opposes the pushing force on the traveling vehicle 1.

The traveling vehicle 1 further includes a vehicle body angle meter 121 that detects an inclination angle of the vehicle body 2, wherein the control ECU 100 controls the posture of the traveling vehicle 1 based on the detected inclination angle and the center of gravity position correcting function if the occupant detection means 152 has not detected the occupant getting off the traveling vehicle 1, and controls the posture based on the detected inclination angle if the occupant detection means 152 has detected the occupant getting off the traveling vehicle. Therefore, the traveling vehicle can be safely moved while also maintaining the posture of the traveling vehicle.

The traveling vehicle 1 further includes a display device 160 that notifies to the outside when the center of gravity position correcting function is canceled. Therefore, it is possible to encourage caution so that a person from outside does not mistakenly apply to the traveling vehicle 1 a force other than that for operation.

The traveling vehicle 1 further includes a drive wheel torque meter 151 that measures an externally applied force when the center of gravity position correcting function is canceled; a drive wheel control ECU 102 that applies an assist torque to the wheel 8 depending on a measurement value of the drive wheel torque meter 151; and a wheel motor 7. Therefore, the traveling vehicle 1 can be easily pushed with little force when the occupant M gets off the traveling vehicle 1 and the traveling vehicle 1 is externally pushed.

### INDUSTRIAL APPLICABILITY

Even if a traveling vehicle is externally pushed after an occupant gets off the traveling vehicle, there is no generation of a force that opposes the pushing force on the traveling vehicle.

1. A traveling vehicle comprising
a vehicle body that has an occupant mounting portion that mounts an occupant; and
a wheel that is provided on a shaft and rotatably supported on the vehicle body, the traveling vehicle comprising:
occupant dismount detection means for detecting the occupant getting off the occupant mounting portion; and
control means having a center of gravity position correcting function for holding the center of gravity position of the traveling vehicle on a vertical line that passes through a center of the wheel, wherein the control means cancels the center of gravity position correcting function if the occupant dismount detection means detects the occupant getting off.

2. The traveling vehicle according to claim 1, further comprising:
vehicle body inclination angle detection means for detecting an inclination angle of the vehicle body, wherein
the control means controls the posture of the traveling vehicle based on the detected inclination angle and the center of gravity position correcting function if the occupant dismount detection means has not detected the occupant getting off the traveling vehicle, and
controls the posture based on the detected inclination angle if the occupant dismount detection means has detected the occupant getting off the traveling vehicle.

3. The traveling vehicle according to claim 2, further comprising:
notification means for notifying when the center of gravity position correcting function is canceled.

4. The traveling vehicle according to claim 3, further comprising:
external force measurement means for measuring an externally applied force when the center of gravity position correcting function is canceled; and
assist means for applying an assist torque to the wheel depending on a measurement value of the external force measurement means.

5. The traveling vehicle according to claim 1, further comprising:
notification means for notifying when the center of gravity position correcting function is canceled.

6. The traveling vehicle according to claim 5, further comprising:
external force measurement means for measuring an externally applied force when the center of gravity position correcting function is canceled; and
assist means for applying an assist torque to the wheel depending on a measurement value of the external force measurement means.

7. The traveling vehicle according to claim 1, further comprising:
external force measurement means for measuring an externally applied force when the center of gravity position correcting function is canceled; and
assist means for applying an assist torque to the wheel depending on a measurement value of the external force measurement means.

8. The traveling vehicle according to claim 2, further comprising:
external force measurement means for measuring an externally applied force when the center of gravity position correcting function is canceled; and
assist means for applying an assist torque to the wheel depending on a measurement value of the external force measurement means.
